(19) United States
(12) Patent Application Publication
(10) Pub. No.: US 2016/0344985 A1
(43) Pub. Date: Nov. 24, 2016

(54) SOLID-STATE IMAGING DEVICE AND CAMERA MODULE

(71) Applicant: Kabushiki Kaisha Toshiba, Minato-ku (JP)

(72) Inventors: Shoji SETA, Arakawa (JP); Yojiro HAMASAKI, Machida (JP)

(73) Assignee: Kabushiki Kaisha Toshiba, Minato-ku (JP)

(21) Appl. No.: 14/974,035

(22) Filed: Dec. 18, 2015

Related U.S. Application Data
(60) Provisional application No. 62/164,982, filed on May 21, 2015.

(51) Int. Cl. H04N 9/04; G02B 13/00; G06K 9/00; G02B 5/20; H04N 5/33; H04N 5/365

(52) U.S. Cl. CPC H04N 9/045; H04N 5/33; H04N 5/3658; G06K 9/0012; G06K 9/00597; G02B 5/208; G02B 13/0085

(57) ABSTRACT

Solid-state imaging devices of embodiments include: a photoelectric conversion element, a first insulating layer and a microlens. The first insulting layer is formed on the photoelectric conversion element. The microlens is formed on the first insulating layer. At least one of the microlens and the first insulating layer includes material to be provided with a band-pass function of causing infrared light of a predetermined wavelength region to pass through.

### FIELD

Embodiments described herein relate generally to a solid-state imaging device and a camera module.

### BACKGROUND

Conventionally, a personal computer, a smartphone and the like have been provided with a security function for judging whether a user is an authorized user or not. Recently, biometric authentication in which personal authentication is performed with use of information about a person's physical characteristics or behavioral characteristics has been widely used as such a security function.

As such biometric authentication, for example, a fingerprint authentication system is the most popular in which personal authentication is performed by detecting a fingerprint of a fingertip and judging whether the fingerprint corresponds to a fingerprint registered in advance. In some cases, however, the fingerprint authentication system cannot correctly detect a fingerprint depending on a state of a fingertip, for example, in a state of the fingertip being sweaty or dry. That is, in some cases, the fingerprint authentication system cannot correctly perform personal authentication depending on a user's state, an environment at that time or the like, and authentication accuracy is low.

Therefore, recently, needs for an iris authentication system in which authentication accuracy is not influenced by a user's state, an environment at that time or the like have been increasing instead of the fingerprint authentication system. The iris authentication system detects a pattern of an iris part existing in an area between an inner side of a black part of an eye and an outer side of a pupil (an iris pattern) to perform personal authentication.

Two types of sensors exist: a type which uses light of a visible region of 380 nm to 700 nm and a type which uses light of a near-infrared region of 700 nm to 900 nm. The type which uses the light of the near-infrared region is used to eliminate color information as far as possible and clearly show an iris pattern.

However, the type which uses the light of the near-infrared region has a demerit that, since sensitivity decreases in comparison with a case of using the light of the visible region, S/N worsens, and it is difficult to recognize an iris pattern. For example, worsening of an S/N ratio can be suppressed by using a highly sensitive band-pass filter. There is, however, a problem of increase in cost.

### BRIEF DESCRIPTION OF THE DRAWINGS

FIG. 1 is a diagram for illustrating an example of use of an iris authentication system;

FIG. 2 is a schematic configuration diagram showing an example of a configuration of a camera module according to a first embodiment;

FIG. 3 is a schematic plane view for illustrating a configuration of a solid-state imaging device of the first embodiment;

FIG. 4 is a schematic partial cross section view of an image pickup area of the solid-state imaging device;

FIG. 5A is a diagram for illustrating an example of a manufacturing method of the solid-state imaging device of the first embodiment;

FIG. 5B is a diagram for illustrating an example of the manufacturing method of the solid-state imaging device of the first embodiment;

FIG. 5C is a diagram for illustrating an example of the manufacturing method of the solid-state imaging device of the first embodiment;

FIG. 6A is a diagram for illustrating a manufacturing method of a solid-state imaging device of a modification of the first embodiment;

FIG. 6B is a diagram for illustrating a manufacturing method of the solid-state imaging device of the modification of the first embodiment;

FIG. 6C is a diagram for illustrating a manufacturing method of the solid-state imaging device of the modification of the first embodiment;

FIG. 7A is a diagram for illustrating a manufacturing method of a solid-state imaging device of a second embodiment;

FIG. 7B is a diagram for illustrating a manufacturing method of the solid-state imaging device of the second embodiment;

FIG. 7C is a diagram for illustrating a manufacturing method of the solid-state imaging device of the second embodiment;

FIG. 7D is a diagram for illustrating a manufacturing method of the solid-state imaging device of the second embodiment;

FIG. 8A is a diagram for illustrating a manufacturing method of a solid-state imaging device of a modification of the second embodiment;

FIG. 8B is a diagram for illustrating a manufacturing method of the solid-state imaging device of the modification of the second embodiment;

FIG. 8C is a diagram for illustrating a manufacturing method of the solid-state imaging device of the modification of the second embodiment;

FIG. 8D is a diagram for illustrating a manufacturing method of the solid-state imaging device of the modification of the second embodiment;

FIG. 9A is a diagram for illustrating a manufacturing method of a solid-state imaging device of a third embodiment;

FIG. 9B is a diagram for illustrating a manufacturing method of the solid-state imaging device of the third embodiment;

FIG. 9C is a diagram for illustrating a manufacturing method of the solid-state imaging device of the third embodiment;

FIG. 9D is a diagram for illustrating a manufacturing method of the solid-state imaging device of the third embodiment; and

FIG. 10 is a schematic partial cross section view of an image pickup area of a solid-state imaging device of a fourth embodiment.

### DETAILED DESCRIPTION

Solid-state imaging devices of embodiments have a photoelectric conversion element, a first insulating layer and a microlens. The first insulting layer is formed on the photoelectric conversion element. The microlens is formed on the first insulating layer. At least one of the microlens and the first insulating layer includes material to be provided with a band-pass function of causing infrared light of a predetermined wavelength region to pass through.

The solid-state imaging devices of the embodiments have the photoelectric conversion element, the first insulating layer and the microlens. The first insulting layer is formed on the photoelectric conversion element. The microlens is formed on the first insulating layer. At least one of the microlens and the first insulating layer includes silicon dioxide and titanium oxide.

A camera module of the embodiments is provided with an optical system and the solid-state imaging device. The solid-state imaging device includes: a photoelectric conversion element, a first insulating layer formed on the photoelectric conversion element, and a microlens formed on the first insulating layer and configured to condense light caused to be incident via the optical system; and at least one of the microlens and the first insulating layer includes material to be provided with a band-pass function of causing infrared light of a predetermined wavelength region to pass through.

Note that, in each figure used for description below, each component is shown on different scale in order to show the component in a size recognizable in the figure, and the present invention is not limited to the number of components, shapes of the components, size ratios among the components, and relative positional relationships among the respective components shown in the figures.

The embodiments will be described below with reference to drawings.

### First Embodiment

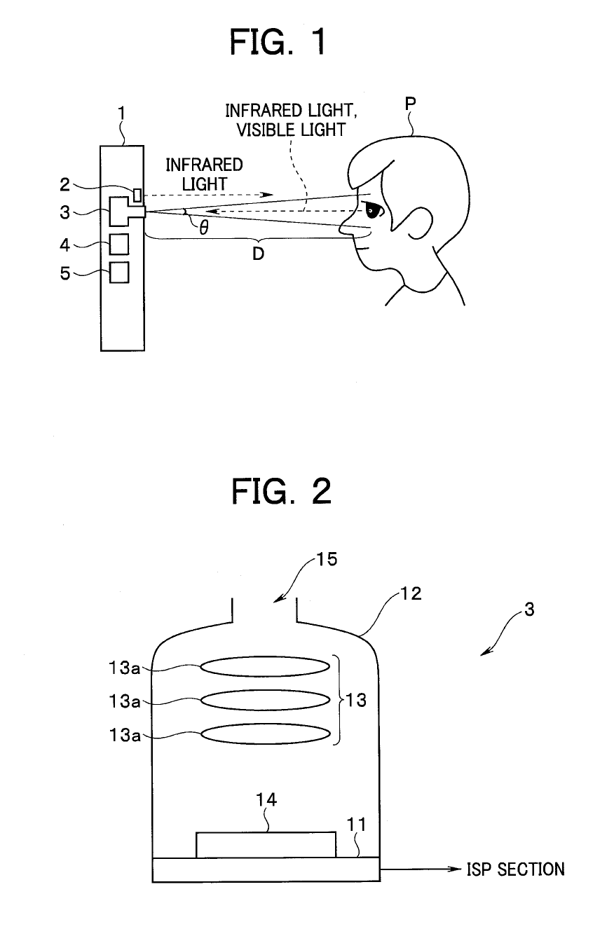

FIG. 1 is a diagram for illustrating an example of use of an iris authentication system, and FIG. 2 is a schematic configuration diagram showing an example of a configuration of a camera module according to a first embodiment.

A mobile terminal 1 such as a smartphone is provided with an iris authentication system which performs pattern matching of an iris part extracted with infrared light to perform personal authentication and is configured having an infrared light emitting section 2 which outputs an infrared light, a camera module 3, an ISP (image signal processor) section 4 and a memory 5.

In a case of performing personal authentication, a user P holds up the mobile terminal 1 away from his face by a distance D of, for example, 25 cm to 45 cm so that infrared light from the infrared light emitting section 2 is emitted toward a vicinity of his eyes. When the user P operates the mobile terminal 1 to start personal authentication, infrared light is emitted from the infrared light emitting section 2 toward the vicinity his eyes. An angle of field θ of the camera module 3 is, for example, 29 degrees, and return light which includes infrared light and visible light from the vicinity of the eyes of the user P is caused to enter the camera module 3.

The distance D between the user P and the mobile terminal 1 at time of performing personal authentication is not limited to 25 cm to 45 cm, and other lengths are also possible. Further, the angle of field θ of the camera module 3 is not limited to 29 degrees, and other angles of field are also possible.

As described later, the camera module 3 picks up an image of return light which includes only infrared light, in return light which includes the infrared light and visible light, and outputs an image pickup signal to the ISP section 4. The ISP section 4 detects an iris pattern of an iris part of the user P from the image pickup signal and performs pattern matching with iris patterns registered with the memory 5 in advance.

The user P photographs the vicinity of his eyes using the infrared light emitting section 2 and the camera module 3 in advance, extracts his iris pattern by the ISP section 4 and registers the iris pattern with the memory 5 as a template in advance. Thereby, the mobile terminal 1 executes iris authentication in which personal authentication is performed with use of the iris pattern.

The camera module 3 of the present embodiment is configured with a substrate 11, and a cover 12 which covers various parts mounted on the substrate 11.

A lens unit 13 and a solid-state imaging device 14 are mounted on the substrate 11. The lens unit 13 is an optical system which has multiple lenses 13a as objective lenses and is capable of focus adjustment.

Each of the multiple lenses 13a for focus adjustment is driven in an optical axis direction by an actuator or the like not shown. Note that, though the lens unit 13 is configured having the three lenses 13a in an example of FIG. 2, the number of the lenses 13a is not limited to three, but other numbers are also possible. Further, the lens unit 13 forms an image of light incident from an opening section 15 provided on the cover 12, on an image pickup surface of the solid-state imaging device 14.

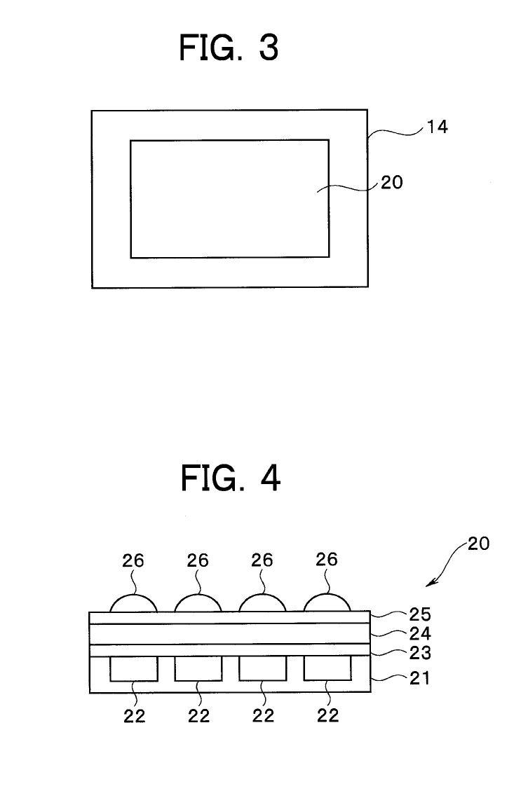

FIG. 3 is a schematic plane view for illustrating a configuration of the solid-state imaging device of the first embodiment, and FIG. 4 is a schematic partial cross section view of an image pickup area of the solid-state imaging device.

As shown in FIG. 3, the solid-state imaging device 14 has an image pickup area 20 on which multiple unit pixels are matrix-arranged in line and column directions in a two-dimensional matrix. As shown in FIG. 4, the image pickup area 20 is configured by photodiodes 22, which are multiple photoelectric conversion elements, an insulating film 23, an infrared (hereinafter referred to as IR) band-pass layer 24 having an IR band-pass filter function, a flattening film 25 and multiple microlenses 26 being arranged on a silicon substrate 21.

As described above, in the present embodiment, a color filter, which is generally formed below the flattening film 25, is deleted so as to increase sensitivity of the solid-state imaging device 14 as far as possible.

The multiple photodiodes 22 as a photodiode layer are arranged below the multiple microlenses 26, respectively, and light transmitted through a corresponding microlens 26 enters each photodiode 22.

The insulating film 23 as a second insulating layer is configured with material such as silicon dioxide (SiO₂), silicon nitride (SiN) or silicon carbide (SiC). The insulating film 23 may be formed in multiple layers or in a single layer. For example, the insulating film 23 may be configured with three layers of SiO₂/SiN/SiO₂. SiO₂ has an effect as passivation, and SiN has an effect as an anti-reflective film and, furthermore, increases adhesion between the photodiodes 22 and the IR band-pass layer 24.

Resin material (organic) or the like is used for the flattening film 25 as a flattening layer, and the flattening film 25 increases flatness as well as increasing adhesion between the microlenses 26 and the IR band-pass layer 24.

The IR band-pass layer 24 as the first insulating layer has a band-pass filter function of causing light of a predetermined infrared light region in return light which includes infrared light and visible light to pass through. The IR band-pass layer 24 is a thin film which includes, for example, titanium oxide (TiOₓ), silicon dioxide (SiO₂) and the like.

More specifically, the IR band-pass layer 24 is configured so as to cause infrared light in a region of 700 nm to 1400 nm to pass through. More preferably, the IR band-pass layer 24 can be configured so as to cause infrared light in a region of 700 nm to 900 nm to pass through. In the present embodiment, it is possible to eliminate visible light remaining in return light from a subject by arranging the IR band-pass layer 24 between the insulating film 23 and the flattening film 25.

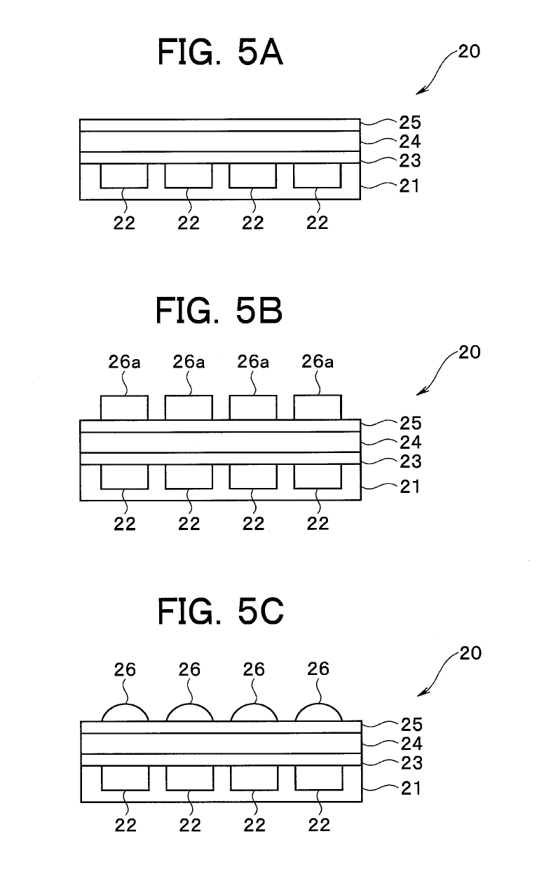

Next, a manufacturing method of the solid-state imaging device configured as above will be described. FIGS. 5A to 5C are diagrams for illustrating an example of the manufacturing method of the solid-state imaging device of the first embodiment.

First, as shown in FIG. 5A, the insulating film 23 is formed on the silicon substrate 21 and the photodiodes 22 by a sputtering method. Next, the IR band-pass layer 24 is formed on the insulating film 23 by the sputtering method, and the flattening film 25 is formed on the IR band-pass layer 24 by the sputtering method.

Next, as shown in FIG. 5B, organic resin material 26a having photosensitivity is pattern-formed on the flattening film 25 by a lithography technique. Lastly, as shown in FIG. 5C, the microlenses 26 in a convex shape are formed from the resin material 26a by a melt method, a gray-scale method or the like.

As described above, in the solid-state imaging device 14, a color filter is not provided below the flattening film 25, but the IR band-pass layer 24 which causes infrared light of a predetermined wavelength region to pass through is provided. Thereby, at time of performing personal authentication using an iris recognition system, color information is eliminated as far as possible, and only infrared light of a predetermined wavelength region is detected from return light which includes visible light and infrared light. As a result, even in a case of performing iris authentication using light of an infrared region, especially light of a wavelength region of a near-infrared region (700 nm to 1400 nm, preferably 700 nm to 900 nm), the sensitivity of the solid-state imaging device 14 can be increased, and the solid-state imaging device 14 can accurately recognize an iris pattern.

Since the IR band-pass layer 24 having the IR band-pass filter function can be provided inside a semiconductor apparatus, it is possible to thin film thickness. Therefore, infrared light sensitivity can be improved.

Note that, though the solid-state imaging device 14 has been described as being used at time of performing iris authentication in the present embodiment, the solid-state imaging device 14 is not limited thereto and can be used, for example, in a medical field, an onboard field and the like. In this case, by changing material of the IR band-pass layer 24 in accordance with a purpose in the medical field, the onboard field or the like, an infrared light band-pass region can be changed to a wavelength region suitable for the purpose.

### Modification

Next, a modification of the first embodiment will be described.

In the modification of the first embodiment, a solid-state imaging device in which IR band-pass filter material is used for all materials below the flattening film 25 will be described.

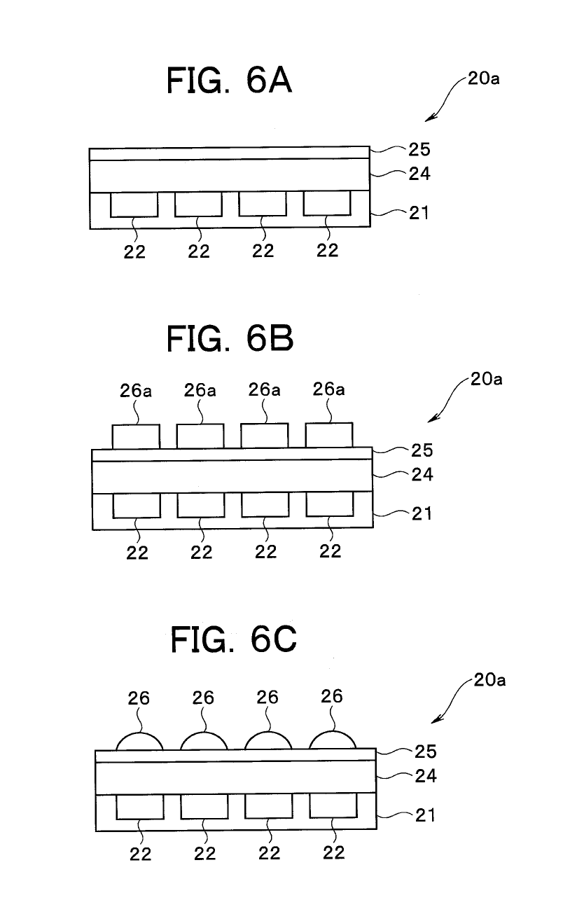

FIGS. 6A to 6C are diagrams for illustrating a manufacturing method of the solid-state imaging device of the modification of the first embodiment. Note that, in FIGS. 6A to 6C, components similar to those in FIGS. 5A to 5C are given same reference numerals, and description thereof will be omitted.

As shown in FIG. 6C, an image pickup area 20a is configured by the multiple photodiodes 22, the IR band-pass layer 24, the flattening film 25 and the multiple microlenses 26 being arranged on the silicon substrate 21.

First, as shown in FIG. 6A, the IR band-pass layer 24 is formed on the silicon substrate 21 and the photodiodes 22 by the sputtering method, and the flattening film 25 is formed on the IR band-pass layer 24 by the sputtering method.

Next, as shown in FIG. 6B, the organic resin material 26a having photosensitivity is pattern-formed on the flattening film 25 by the lithography technique. Furthermore, as shown in FIG. 6C, the microlenses 26 in a convex shape are formed from the resin material 26a by the melt method, the gray-scale method or the like.

As described above, the solid-state imaging device 14 of the modification of the first embodiment can increase sensitivity and accurately recognize an iris pattern even in a case of performing iris authentication using light of an infrared region, similarly to the first embodiment.

### Second Embodiment

Next, a second embodiment will be described.

In the second embodiment, a solid-state imaging device in which microlenses are integrated with the IR band-pass layer 24 will be described.

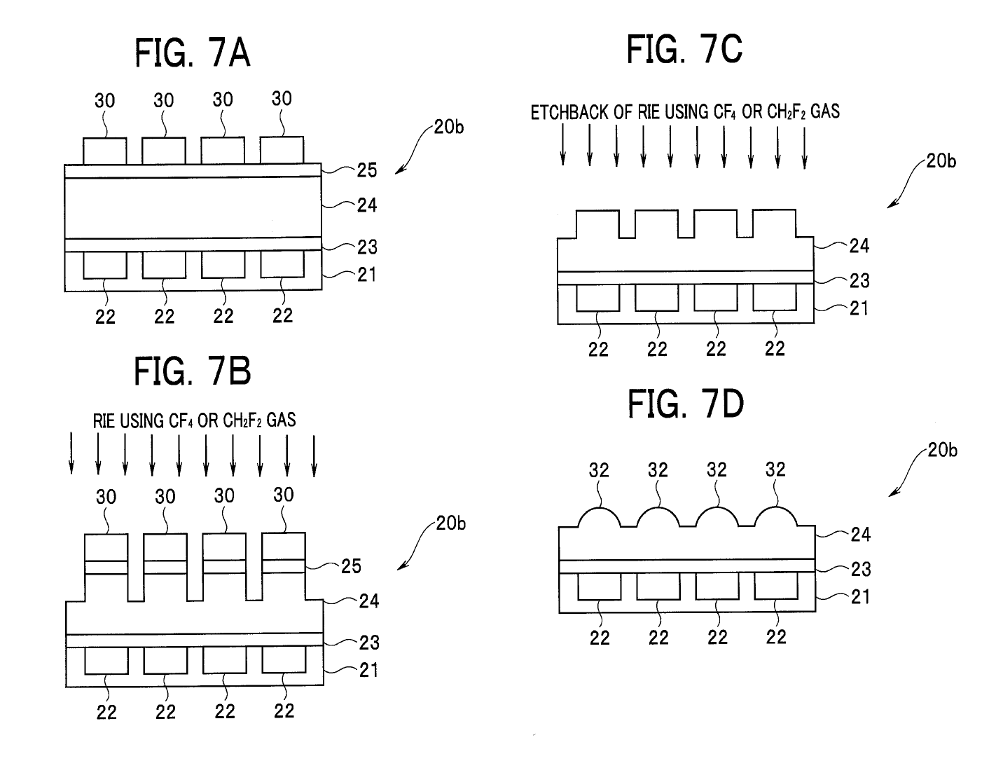

FIGS. 7A to 7D are diagrams for illustrating a manufacturing method of the solid-state imaging device of the second embodiment. Note that, in FIGS. 7A to 7D, components similar to those in FIGS. 5A to 5C are given same reference numerals, and description thereof will be omitted.

As shown in FIG. 7D, the image pickup area 20b is configured by the multiple photodiodes 22, the insulating film 23, and the IR band-pass layer 24 which is made of IR band-pass filter material and which includes microlenses 32 being arranged on the silicon substrate 21.

First, as shown in FIG. 7A, the insulating film 23, the IR band-pass layer 24 and the flattening film 25 are formed on the silicon substrate 21 and the photodiodes 22 by the sputtering method, and resist material 30 is pattern-formed. Note that the flattening film 25 is not necessarily required to be formed, and it is also possible to faun the insulating film 23 and the IR band-pass layer 24 on the silicon substrate 21 and the photodiodes 22 by the sputtering method and pattern-form the resist material 30.

Next, as shown in FIG. 7B, etching of the IR band-pass layer 24 is performed up to a predetermined depth by reactive ion etching (hereinafter referred to as RIE) using tetrafluoromethane (CF₄) or difluoromethane (CH₂F₂) gas, which is high-purity etching gas for semiconductor manufacturing.

Next, as shown in FIG. 7C, the flattening film 25 and the resist material 30 are detached, and RIE etch back using CF₄ or CH₂F₂ gas is performed. Next, as shown in FIG. 7D, the microlenses 32 are formed by isotropic etching or the like.

As described above, in the solid-state imaging device 14 of the present embodiment, the microlenses 32 and a layer below the microlenses 32 are formed integrally by the IR band-pass layer 24 and are caused to have the band-pass filter function of causing infrared light of a predetermined wavelength region to be transmitted. That is, the solid-state imaging device 14 causes even the microlenses 32 to cut light of a visible light wavelength region in incident return light which includes infrared light and visible light by the band-pass filter function. As a result, the solid-state imaging device 14 of the present embodiment can increase infrared light sensitivity higher than the first embodiment and can recognize an iris pattern more accurately than the first embodiment. Furthermore, since the microlenses 32 is formed integrally with the IR band-pass layer 24, the flattening film 25 is not required, and it is possible to further increase the infrared light sensitivity.

### Modification

Next, a modification of the second embodiment will be described.

In the modification of the second embodiment, a solid-state imaging device will be described in which all of microlenses and materials below the microlenses are formed as the IR band-pass layer 24.

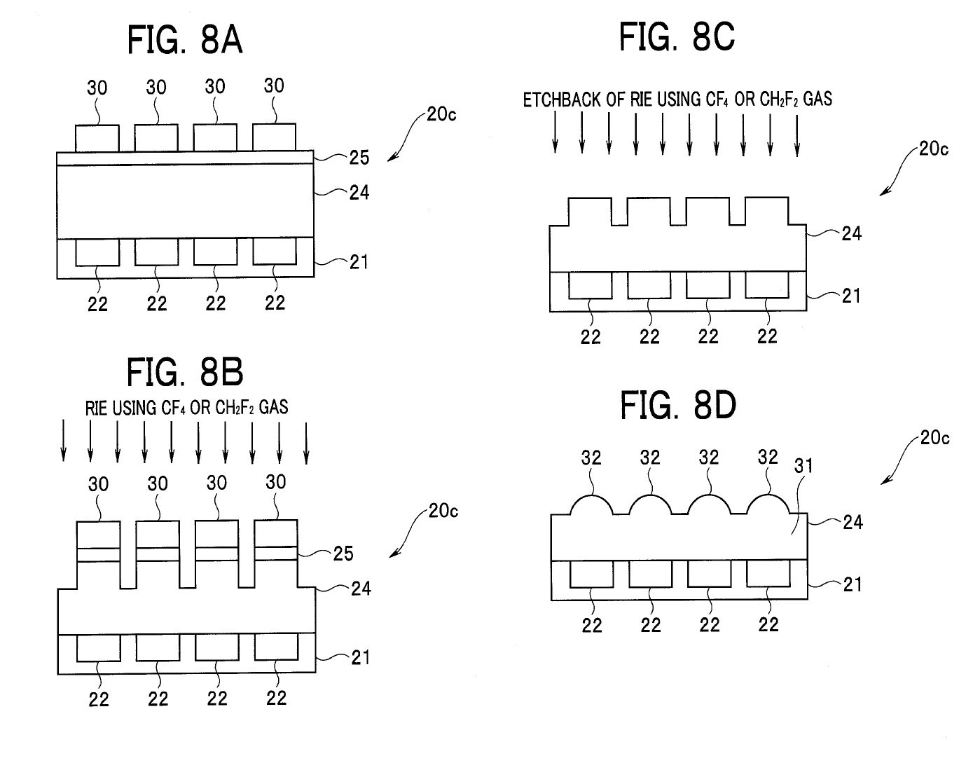

FIGS. 8A to 8D are diagrams for illustrating a manufacturing method of the solid-state imaging device of the modification of the second embodiment. Note that, in FIGS. 8A to 8D, components similar to those in FIGS. 7A to 7D are given same reference numerals, and description thereof will be omitted.

As shown in FIG. 8D, an image pickup area 20c is configured by the multiple photodiodes 22, and the IR band-pass layer 24 which includes the microlenses 32 being arranged on the silicon substrate 21.

First, as shown in FIG. 8A, the IR band-pass layer 24 and the flattening film 25 are formed on the silicon substrate 21 and the photodiodes 22 by the sputtering method, and the resist material 30 is pattern-formed. Note that the flattening film 25 is not necessarily required to be formed, and it is also possible to form the IR band-pass layer 24 on the silicon substrate 21 and the photodiodes 22 by the sputtering method and pattern-form the resist material 30. Next, as shown in FIG. 8B, etching of the IR band-pass layer 24 is performed up to a predetermined depth by RIE using CF₄ or CH₂F₂ gas.

Next, as shown in FIG. 8C, the flattening film 25 and the resist material 30 are detached, and RIE etch back using CF₄ or CH₂F₂ gas is performed. Next, as shown in FIG. 8D, the microlenses 32 are formed by isotropic etching or the like. The microlenses 32 are formed integrally with the IR band-pass layer 24.

As described above, the solid-state imaging device 14 of the modification of the second embodiment can increase sensitivity higher than the first embodiment and recognize an iris pattern more accurately than the first embodiment similarly to the second embodiment.

### Third Embodiment

Next, a third embodiment will be described.

In the third embodiment, a solid-state imaging device in which IR band-pass filter material is used only for microlenses will be described.

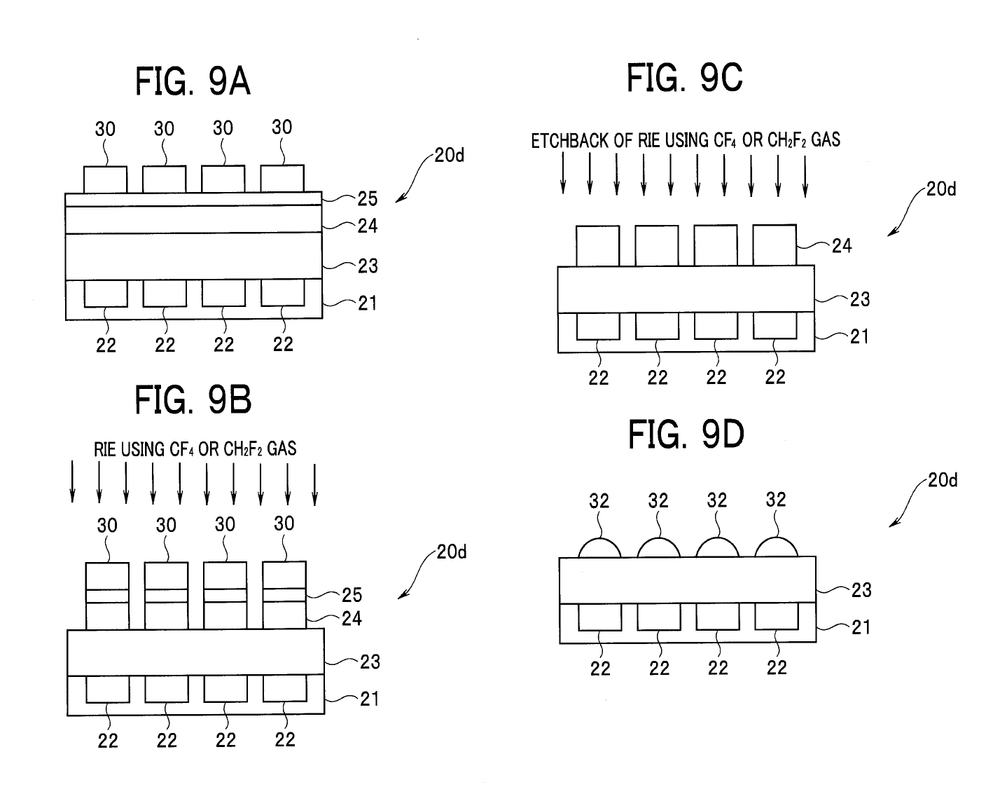

FIGS. 9A to 9D are diagrams for illustrating a manufacturing method of the solid-state imaging device of the third embodiment. Note that, in FIGS. 9A to 9D, components similar to those in FIGS. 7A to 7D are given same reference numerals, and description thereof will be omitted.

As shown in FIG. 9D, an image pickup area 20d is configured by the multiple photodiodes 22, the insulating film 23, and the microlenses 32 including IR band-pass filter material being arranged on the silicon substrate 21.

First, as shown in FIG. 9A, the insulating film 23, the IR band-pass layer 24 and the flattening film 25 are formed on the silicon substrate 21 and the photodiodes 22 by the sputtering method, and resist material 30 is pattern-formed. Note that the flattening film 25 is not necessarily required to be formed, and it is also possible to form the insulating film 23 and the IR band-pass layer 24 on the silicon substrate 21 and the photodiodes 22 by the sputtering method and pattern-form the resist material 30.

Next, as shown in FIG. 9B, etching of the IR band-pass layer 24 is performed up to depth of the insulating film 23 by RIE using CF₄ or CH₂F₂ gas.

Next, as shown in FIG. 9C, the flattening film 25 and the resist material 30 is detached, and RIE etch back using CF₄ or CH₂F₂ gas is performed. Next, as shown in FIG. 9D, the microlenses 32 constituted by the IR band-pass layer 24 are formed by isotropic etching or the like.

As described above, the solid-state imaging device 14 of the present embodiment causes the microlenses 32 to have the band-pass filter function of causing infrared light of a predetermined wavelength region to be transmitted. That is, the solid-state imaging device 14 causes light of the visible light wavelength region in incident return light which includes infrared light and visible light to be cut by the band-pass filter function of the microlenses 32. As a result, the solid-state imaging device 14 of the present embodiment can increase sensitivity and accurately recognize an iris pattern even in the case of performing iris authentication using light of an infrared region, similarly to the first embodiment.

### Fourth Embodiment

Next, a fourth embodiment will be described.

In the fourth embodiment, a solid-state imaging device in which AR (anti-reflective) coating is provided on microlenses will be described.

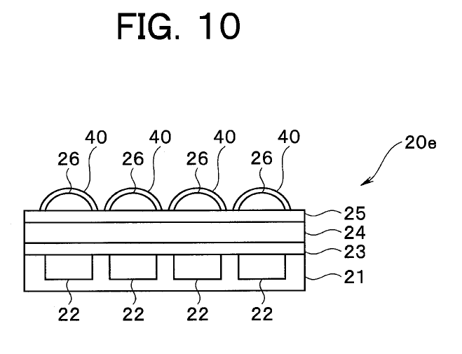

FIG. 10 is a schematic partial cross section view of an image pickup area of the solid-state imaging device of the fourth embodiment. Note that, in FIG. 10, components similar to those in FIG. 4 are given same reference numerals, and description thereof will be omitted.

As shown in FIG. 10, in an image pickup area 20e, a thin film 40 which includes silicon dioxide (SiO₂) or the like is vapor-deposited on a surface of the microlenses 26. Other components are similar to those of the first embodiment.

The thin film 40 causes light of the visible light wavelength region to be reflected and causes light of an infrared light wavelength region to be transmitted. That is, the thin film 40 has a cut filter function of cutting the visible light wavelength region. As for the light of the infrared light wavelength region transmitted through the thin film 40, only light of a predetermined wavelength region of infrared light is transmitted by the IR band-pass layer 24 and caused to enter the photodiodes 22.

As described above, the solid-state imaging device 14 of the present embodiment causes light of the visible light wavelength region to be reflected by the thin film 40 vapor-deposited on the microlenses 26, causes only light of the predetermined wavelength region of infrared light to be transmitted by the IR band-pass layer 24. That is, the solid-state imaging device 14 causes light of the visible light wavelength region in incident return light which includes infrared light and visible light to be cut by both of the cut filter function of the thin film 40 and the band-pass filter function of the IR band-pass layer 24. As a result, the solid-state imaging device 14 of the present embodiment can increase sensitivity higher than the first embodiment and recognize an iris pattern more accurately than the first embodiment.

Here, material mixed in the microlenses and material vapor-deposited on the microlenses will be described. The material mixed in the IR band-pass layer 24 is silicon dioxide (SiO₂) and titanium oxide (TiOₓ). Note that, as for the material mixed in the IR band-pass layer 24, silicon dioxide (SiO₂) and titanium oxide (TiOₓ), are essential material. By adjusting a composition ratio of silicon dioxide (SiO₂) and titanium oxide (TiOₓ), a band-pass filter capable of causing a predetermined wavelength region to pass through can be formed. Note that, in addition to the above two kinds of material, different material may be mixed.

Further, material of the thin film 40 to be vapor-deposited on the microlenses 26 is trititanium pentoxide (Ti₃O₅) and silicon dioxide (SiO₂), which are included at a predetermined ratio. As for the thin film 40 also, other different materials may be mixed similarly to the IR band-pass layer 24.

Note that, though description has been made with a mobile terminal as an example in the embodiments, the present invention is not limited to a mobile terminal, and an effect can be also obtained by using the present invention for a fixed iris authentication system.

While certain embodiments have been described, these embodiments have been presented by way of example only, and are not intended to limit the scope of the inventions. Indeed, the novel devices described herein may be embodied in a variety of other forms; furthermore, various omissions, substitutions and changes in the form of the devices described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a photoelectric conversion element;
a first insulating layer formed on the photoelectric conversion element; and
a microlens formed on the first insulating layer; wherein
at least one of the microlens and the first insulating layer includes material to be provided with a band-pass function of causing infrared light of a predetermined wavelength region to pass through.

2. The solid-state imaging device according to claim 1, wherein the material to be provided with the band-pass function includes silicon dioxide and titanium oxide.

3. The solid-state imaging device according to claim 1, further comprising a thin film including material causing light of a visible light wavelength region to be reflected and formed on a surface of the microlens.

4. The solid-state imaging device according to claim 3, wherein the thin film has a function of causing light of an infrared light wavelength region to pass through.

5. The solid-state imaging device according to claim 3, wherein the material of the thin film includes trititanium pentoxide and silicon dioxide.

6. The solid-state imaging device according to claim 1, further comprising a flattening layer provided between the microlens and the first insulating layer.

7. The solid-state imaging device according to claim 1, further comprising a second insulating layer provided between the first insulating layer and the photoelectric conversion element.

8. The solid-state imaging device according to claim 1, wherein the first insulating layer and the microlens are formed with same material.

9. The solid-state imaging device according to claim 8, wherein the first insulating layer and the microlens are integrally formed.

10. A solid-state imaging device comprising:
a photoelectric conversion element;
a first insulating layer formed on the photoelectric conversion element; and
a microlens formed on the first insulating layer; wherein
at least one of the microlens and the first insulating layer includes silicon dioxide and titanium oxide.

11. The solid-state imaging device according to claim 10, further comprising a thin film including trititanium pentoxide and silicon dioxide causing light of a visible light wavelength region to be reflected and formed on a surface of the microlens.

12. The solid-state imaging device according to claim 10, further comprising a flattening layer provided between the microlens and the first insulating layer.

13. The solid-state imaging device according to claim 10, further comprising a second insulating layer provided between the first insulating layer and the photoelectric conversion element.

14. A camera module comprising:
an optical system; and
a solid-state imaging device comprising: a photoelectric conversion element, a first insulating layer formed on the photoelectric conversion element, and a microlens formed on the first insulating layer and configured to condense light caused to be incident via the optical system, wherein at least one of the microlens and the first insulating layer includes material to be provided with a band-pass function of causing infrared light of a predetermined wavelength region to pass through.

15. The camera module according to claim 14, wherein the material to be provided with the band-pass function includes silicon dioxide and titanium oxide.

16. The camera module according to claim 14, further comprising a thin film including material causing light of a visible light wavelength region to be reflected and formed on a surface of the microlens.

17. The camera module according to claim 16, wherein the material of the thin film includes trititanium pentoxide and silicon dioxide.

18. The camera module according to claim 14, further comprising a flattening layer provided between the microlens and the first insulating layer.

19. The camera module according to claim 14, further comprising a second insulating layer provided between the first insulating layer and the photoelectric conversion element.

20. The camera module according to claim 14, wherein
the first insulating layer and the microlens are integrally formed; and
the first insulating layer and the microlens that are integrally formed include the material to be provided with the band-pass function.
